(19) United States
(12) Patent Application Publication
(10) Pub. No.: US 2014/0093641 A1
(43) Pub. Date: Apr. 3, 2014

(54) LUBRICANT COMPOSITIONS CONTAINING FLUOROOXIRANES

(71) Applicants: Richard M. Minday, Stillwater, MN (US); Jason M. Kehren, Stillwater, MN (US); John G. Owens, Woodbury, MN (US); Michael J. Bulinski, Houlton, WI (US); Michael G. Costello, Afton, MN (US); Richard M. Flynn, Mahtomedi, MN (US)

(72) Inventors: Richard M. Minday, Stillwater, MN (US); Jason M. Kehren, Stillwater, MN (US); John G. Owens, Woodbury, MN (US); Michael J. Bulinski, Houlton, WI (US); Michael G. Costello, Afton, MN (US); Richard M. Flynn, Mahtomedi, MN (US)

(73) Assignee: 3MM INNOVATIVE PROPERTIES COMPANY, St. Paul, MN (US)

(21) Appl. No.: 13/984,133

(22) PCT Filed: Feb. 8, 2012
(86) PCT No.: PCT/US12/24301

§ 371 Date: Aug. 7, 2013

Related U.S. Application Data
(60) Provisional application No. 61/448,826, filed on Mar. 3, 2011.

(51) Int. Cl. C10M 131/10; G11B 5/725

(52) U.S. Cl. CPC C10M 131/10; G11B 5/725
USPC 427/127; 508/304; 427/331

(57) ABSTRACT

An lubricant composition comprising a C₄ to C₁₅ fluorooxirane fluid having a boiling point ≧20° C., and a lubricant soluble or dispersible therein, is provided.

### CROSS REFERENCE TO RELATED APPLICATION

This application claims the benefit of U.S. Provisional Patent Application No. 61/448,826, filed Mar. 3, 2011, the disclosure of which is incorporated by reference herein in its entirety.

### FIELD OF THE INVENTION

This invention relates to fluorinated oxiranes (fluorooxiranes) and the use thereof in cleaning and coating applications, in particular the deposition of lubricants for magnetic media.

### BACKGROUND

Certain perfluorinated alkanes have been used in place of chlorofluorocarbons as solvents such as those described in U.S. Pat. No. 4,721,795 (Caporiccio et al.). Additionally, U.S. Pat. No. 5,049,410 (Flynn et al.) discloses the use of a perfluorinated, nonaromatic cyclic organic solvent for dissolution of polyfluoropolyether lubricants. However, some of these compounds tend to have relatively long atmospheric lifetimes and can potentially contribute to global warming.

Thus, there is a need for solvents with short atmospheric lifetimes that dissolve polyfluoropolyether lubricants. The invention provides fluorooxirane solvents with these desirable characteristics.

### SUMMARY

The fluorooxirane compounds can be used in a number of different applications including, for example, use as a solvent in coating deposition, and as a cleaning fluid. In one aspect, this disclosure provides a process for depositing a coating on a substrate comprising applying to at least a portion of at least one surface of the substrate a composition comprising (a) a solvent composition comprising at least one fluorooxirane compound of the invention; and (b) at least one coating material (for example, a fluorochemical polyether) that is soluble or dispersible in the solvent composition. In another aspect, this disclosure provides a process for removing a contaminant (for example, an oil or grease, a particulate, or water) from an article comprising contacting the article with a composition comprising at least one fluorooxirane compound.

Briefly, the present disclosure provides one or more fluorooxiranes of the formula:

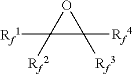

wherein each of R_{f}¹, R_{f}², R_{f}³ and R_{f}⁴ are selected from a hydrogen atom, a fluorine atom or a fluoroalkyl group, preferably a fluorine atom or a perfluoroalkyl group, and has a boiling point ≧20° C. Generally, the number of carbon atoms of said fluorooxiranes is 4 to 15. In some embodiments any two of said R_{f} groups may be joined together to form a fluorocycloalkyl ring, preferably a perfluorocycloalkyl ring. The C₄-C₁₅ fluorooxiranes have 3 or fewer hydrogen atoms, preferably zero hydrogen atoms.

The fluorooxirane compounds are hydrophobic and oleophobic, chemically unreactive, hydrolytically stable, thermally stable, water insoluble, can be made in high yield, and have relatively low global warming potentials and ozone depletion potentials.

In the present disclosure:

“fluorinated” refers to hydrocarbon compounds that have one or more C—H bonds replaced by C—F bonds;

“fluoroalkyl has essentially the meaning as “alkyl” except that one or more of the hydrogen atoms of the alkyl radical are replaced by fluorine atoms.

“fluoroalkylene has essentially the meaning as “alkylene” except that one or more of the hydrogen atoms of the alkyl radical are replaced by fluorine atoms.

“Perfluoroalkyl” has essentially the meaning as “alkyl” except that all or essentially all of the hydrogen atoms of the alkyl radical are replaced by fluorine atoms, e.g. perfluoropropyl, perfluorobutyl, perfluorooctyl, and the like.

“Perfluoroalkylene” has essentially the meaning as “alkylene” except that all or essentially all of the hydrogen atoms of the alkylene radical are replaced by fluorine atoms, e.g., perfluoropropylene, perfluorobutylene, perfluorooctylene, and the like

“Perfluorinated” or the prefix “perfluoro” means an organic group wherein all or essentially all of the carbon bonded hydrogen atoms are replaced with fluorine atoms, e.g. perfluoroalkyl, and the like.

As used herein, “GWP” is a relative measure of the warming potential of a compound based on the structure of the compound. The GWP of a compound, as defined by the Intergovernmental Panel on Climate Change (IPCC) in 1990 and updated in 2007, is calculated as the warming due to the release of 1 kilogram of a compound relative to the warming due to the release of 1 kilogram of CO₂ over a specified integration time horizon (ITH).

$${GWP}_{i} ( {t}^{′} ) = \frac{{\int }_{0}^{ITH} {a}_{i} [ C ( t ) ] d t}{{\int }_{0}^{ITH} {a}_{CO 2} [ {C}_{CO 2} ( t ) ] d t} = \frac{{\int }_{0}^{ITH} {a}_{i} {C}_{oi} {e}^{- t / {τ}_{l}} d t}{{\int }_{0}^{ITH} {a}_{CO 2} [ {C}_{CO 2} ( t ) ] d t}$$

In this equation aᵢ is the radiative forcing per unit mass increase of a compound in the atmosphere (the change in the flux of radiation through the atmosphere due to the IR absorbance of that compound), C is the atmospheric concentration of a compound, τ is the atmospheric lifetime of a compound, t is time and i is the compound of interest.

The commonly accepted ITH is 100 years representing a compromise between short-term effects (20 years) and longer-term effects (500 years or longer). The concentration of an organic compound, i, in the atmosphere is assumed to follow pseudo first order kinetics (i.e., exponential decay). The concentration of CO₂ over that same time interval incorporates a more complex model for the exchange and removal of CO₂ from the atmosphere (the Bern carbon cycle model).

As a result of their degradation in the lower atmosphere, the fluorooxiranes have shorter lifetimes and would contribute less to global warming, as compared to perfluoroalkanes. The lower GWP of the fluorooxiranes, in addition to the physical properties, make them well suited for use in cleaning and coating applications.

Perfluorooxiranes that are useful in the present invention include those oxiranes having only fluorine attached to the carbon backbone. More specifically, the instant perfluorooxiranes are of formula:

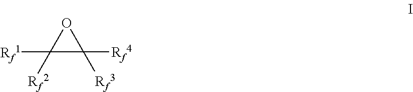

wherein each of R_{f}¹, R_{f}², R_{f}³ and R_{f}⁴ are selected from a fluorine atom or a perfluoroalkyl group and has a boiling point ≧20° C. Generally, the number of carbon atoms of said perfluorooxiranes is 5 to 15. In some embodiments any two of said R_{f} groups may be joined together to form a perfluorocycloalkyl ring.

Fluorooxiranes that are useful in the present invention also include those oxiranes having three of fewer hydrogen atoms attached to the carbon backbone. More specifically, useful fluorinated oxiranes are of the formula I wherein each of R_{f}¹, R_{f}², R_{f}³ and R_{f}⁴ are selected from a fluorine atom, a hydrogen atom or a fluoroalkyl group; wherein the sum of the hydrogen atoms is ≦3 and wherein the sum of the carbon atoms of the fluorinated oxirane is 4 to 15 and have a boiling point of ≧20° C.

In some embodiments any two of said R_{f} groups may be joined together to form a fluorocycloalkyl ring of the formula:

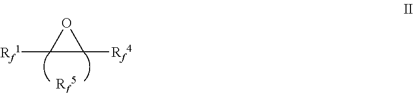

wherein each of R_{f}¹, and R_{f}⁴ are selected from a hydrogen atom, a fluorine atom or a fluoroalkyl group, R_{f}⁵ is a fluoroalkylene group of 2 to 5 carbon atoms, and has a boiling point of ≧20° C. Generally the sum of the carbon atoms is 4 to 15. Preferably each of R_{f}¹ and R_{f}⁴ are selected from a fluorine atom or a perfluoroalkyl group. In some embodiments cyclic fluorooxiranes are preferred

With respect to Formulas I and II, R_{f}¹ to R_{f}⁴ are each F, or monovalent fluoroalkyl groups having 1 to 8 fluorinated carbon atoms, optionally containing one or more catenary (in-chain) heteroatoms, such as divalent oxygen, or trivalent nitrogen bonded only to carbon atoms, such heteroatoms being a chemically stable link between perfluorocarbon portions of the perfluoroaliphatic group and which do not interfere with the inert character of the perfluoroaliphatic group. In preferred embodiments, R_{f}¹ to R_{f}⁴ are fluorine atoms or perfluoroalkyl groups. The skeletal chain of R_{f}¹ to R_{f}⁴ can be straight chain, branched chain, and if sufficiently large, cyclic, such as fluorocycloaliphatic groups, e.g. R_{f}⁵ as shown in Formula II. In some embodiments at least one of R_{f}¹ to R_{f}⁴ is a branched perfluoraliphatic group.

Preferred fluorooxiranes useful in the present invention include oxiranes which are perfluorinated, i.e., all of the hydrogen atoms in the carbon backbone have been replaced with fluorine atoms. The carbon backbone can be linear, branched, or cyclic, or combinations thereof, and will preferably have about 4 to about 15 carbon atoms. Representative examples of perfluorooxirane compounds suitable for use in the processes and compositions of the invention include 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, and oxiranes of HFP trimers, including 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane, 2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane.

Other oxiranes useful in the invention include fluorinated oxiranes with one to three hydrogen atoms. Representative examples include 2,3-bis-trifluoromethyl-oxirane, 2-pentafluoroethyl-3-trifluoromethyl-oxirane, 2-(1,2,2,2-tetrafluoro-1-trifluoromethyl-ethyl)-3-trifluoromethyl-oxirane, 2-nonafluorobutyl-3-pentafluoroethyl-oxirane, 2,2-bis-trifluoromethyl-oxirane, 2,3-difluoro-2-trifluoromethyl-oxirane, 2-heptafluoroisopropyloxirane, 2-heptafluoropropyloxirane, 2-nonafluorobutyloxirane, 2-tridecafluorohexyloxirane and 3-fluoro-2,2-bis-trifluoromethyl-oxirane.

The R_{f} groups of the fluorooxiranes optionally contain one or more catenary (i.e. in-chain) heteroatoms interrupting the carbon backbone. Suitable heteroatoms include, for example, nitrogen and oxygen atoms. Representative examples of such fluorooxiranes include 2-[difluoro-(2,3,3-trifluorooxiran-2-yl)methoxy]-1,1,2,2-tetrafluoro-N,N-bis(1,1,2,2,2-pentafluoroethyl)ethanamine, and 2-[difluoro(1,1,2,2,3,3,4,4,4-nonafluorobutoxy)methyl]-2,3,3-trifluoro-oxirane. Inclusion of such catenary heteroatoms is not preferred.

In addition to demonstrating lubrication performance, perfluorooxiranes can offer additional important benefits in safety of use and in environmental properties. For example, 2,3-difluoro-2-(1,2,2,2-tetrafluoro-1-trifluoromethyl-ethyl)-3-trifluoromethyl-oxirane, has low acute toxicity, based on short-term inhalation tests with rats exposed for four hours at a concentration of 50,000 ppm in air. The perfluorooxiranes derived from HFP trimer have low acute toxicity based on short-term inhalation tests with rats exposed for four hours at a concentration of 4,000 ppm in air.

The fluorooxiranes are derived from fluorinated olefins that have been oxidized with epoxidizing agents. In the perfluorooxirane compositions the carbon backbone includes the whole carbon framework including the longest hydrocarbon chain (main chain) and any carbon chains branching off of the main chain. In addition, there can be one or more catenated heteroatoms interrupting the carbon backbone such as oxygen or nitrogen atoms, for example ether or tertiary amine functionalities. The catenated heteroatoms are not directly bonded to the oxirane ring. In these cases the carbon backbone includes the heteroatoms and the carbon framework attached to the heteroatom.

The fluorooxirane compounds can be prepared by epoxidation of the corresponding fluorinated olefin using an oxidizing agent such as sodium hypochlorite, hydrogen peroxide or other well known epoxidizing agent such as peroxycarboxylic acids including metachloroperbenzoic acid or peracetic acid. The fluorinated olefinic precursors can be directly available as, for example, in the cases of 1,1,1,2,3,4,4,5,5,5-decafluoro-pent-2-ene (for making 2,3-difluoro-2-trifluoromethyl-3-pentafluoroethyl-oxirane) or 1,2,3,3,4,4,5,5,6 decafluoro-cyclohexene (for making 1,2,2,3,3,4,4,5,5,6-decafluoro-7-oxa-bicyclo[4.1.0]heptane). Other useful fluorinated olefinic precursors can include oligomers of hexafluoropropene (HFP) and tetrafluoroethylene (TFE) such as dimers and trimers.

The HFP oligomers can be prepared by contacting 1,1,2,3,3,3-hexafluoro-1-propene (hexafluoropropene) with a catalyst or mixture of catalysts selected from the group consisting of alkali metal, quaternary ammonium, and quaternary phosphonium salts of cyanide, cyanate, and thiocyanate of in the presence of polar, aprotic solvents such as, for example, acetonitrile. The preparation of these HFP oligomers is disclosed, for example, in U.S. Pat. No. 5,254,774 (Prokop). Useful oligomers include HFP trimers or HFP dimers. HFP dimers include a mixture of isomers of C₆F₁₂. HFP trimers include a mixture of isomers of C₉F₁₈.

The present disclosure provides fluorooxirane compounds for use in coating applications. Such processes for depositing a coating on a substrate (for example, magnetic recording media or cellulose-based materials) comprises applying, to at least a portion of at least one surface of the substrate, a composition comprising (a) a solvent composition comprising at least one fluorooxirane compound; and (b) at least one coating material that is soluble or dispersible in the solvent composition. In using the fluorooxirane compounds as deposition solvents in coating applications or in document or biological specimen preservation applications, the processes described in, for example, U.S. Pat. No. 5,925,611 (Flynn et al.) and U.S. Pat. No. 6,080,448 (Leiner et al.) can be used, which descriptions are incorporated herein.

Coating materials that can be deposited by the process include pigments, lubricants, stabilizers, adhesives, anti-oxidants, dyes, polymers, pharmaceuticals, release agents, inorganic oxides, document preservation materials (for example, alkaline materials used in the deacidification of paper), and the like, and combinations thereof. Preferred materials include perfluoropolyether, hydrocarbon, and silicone lubricants; amorphous copolymers of tetrafluoroethylene; polytetrafluoroethylene; document preservation materials; specimen preservation materials; and combinations thereof. Most preferably, the material is a perfluoropolyether or a document or specimen preservation material.

In a one embodiment, this disclosure provides a lubricant composition comprising about 0.01 to about 10 weight percent perfluoropolyether lubricant and about 90 to about 99.99 weight percent fluorooxirane based on the weight of the lubricant composition. The lubricant composition typically has low solubility for possible contaminants such as water, silicones, and general hydrocarbons. Additionally, the lubricant composition can have low global warming potential.

In coating applications, the fluorooxirane compounds can be used alone or in admixture with each other or with other commonly-used solvents (for example, ethers, alkanes, alkenes, perfluorocarbons, perfluorinated tertiary amines, perfluoroethers, cycloalkanes, esters, ketones, aromatics, siloxanes, hydrochlorocarbons, hydrochlorofluorocarbons, hydrofluorocarbons, and the like, and mixtures thereof). Such co-solvents are preferably at least partially fluorinated, can be chosen to modify or enhance the properties of a composition for a particular use, and can be utilized in ratios (of co-solvent(s) to fluorooxirane (s)) such that the resulting composition preferably has no flash point. If desired, the fluorooxirane compounds can be used in combination with other compounds that are very similar in properties relative to a particular use (for example, other fluorochemical compounds. Generally up to 50 weight percent, generally up to 10 weight percent of the fluorooxirane solvent is replaced with a co-solvent.

Magnetic media is commonly used in the computer industry for storing large amounts of data. Magnetic recording occurs by moving magnetic media past a magnetic record head consisting of a small electromagnet with a gap. To record information on the magnetic media, a current is applied to the windings of the electromagnet creating a magnetic field in the gap region. The magnetic field affects the polarity of the magnetic materials in the magnetic media that are in close proximity to the head gap. Changing the direction of current flow can reverse the direction of magnetization and the polarity of the magnetic materials. To read information from magnetic media, a read head constructed similarly to the record head is brought into close proximity with the magnetic media. The magnetic field of the magnetic media induces a voltage in the read head. The voltage changes when the direction of the magnetic field from the magnetic media changes.

During normal operation, the magnetic media is moved or rotated relative to the record head with a small space between the media and the head. At the end of the recording process, the magnetic media is often in direct physical contact with the head. The frictional force produced can wear both the head and the magnetic media. Eventually, the frictional force can become large enough to damage either the media or the head.

To minimize the wear of the magnetic disk and head, a lubricant is placed on the surface of the magnetic media. The presence of the lubricant improves the durability of the magnetic media. Typically, the lubricant is a perfluoropolyether (PFPE) with functionalized end groups. Perfluoropolyether lubricants are chemically inert, thermally stable, moisture repellent compositions that possess relatively low surface tension, good lubricity and low volatility. As a result, they can be effective and long-lasting lubricants for magnetic media.

The trend in the computer industry is to increase the recording density. Increasing recording density can be achieved by increasing the output signal of the magnetic media. However, a lubricant layer between the record head and the magnetic material of the magnetic media diminishes the intensity of the signal that can be recorded or read. The decreased signal intensity is due, at least in part, to an increased distance between the head and the magnetic material due to the presence of the lubricant layer. Consequently, to maximize the output signal, a thin lubricant coating is often preferred. State-of-the-art magnetic media typically has a lubricant layer thickness below about 2 nm. The lubricant usually is applied as a dilute solution in a suitable solvent. After application of the lubricant composition, the solvent is evaporated leaving a thin, uniform lubricant coating.

Perfluoropolyethers have been extensively used as lubricants for magnetic media. Various perfluoropolyether lubricants have been described, for example, in U.S. Pat. No. 4,721,795 (Caporiccio et al.) and U.S. Pat. No. 5,049,410 (Johary et al.) Many perfluoropolyether lubricants contain a mixture of perfluoropolyether compounds with a variety of molecular weights and structures. These lubricants have limited solubility in most solvents.

More than one fluorooxirane can be used in the lubricant composition. In some embodiments, one or more miscible solvents can replace a portion of the fluorooxirane. For example, up to about 10 weight percent of the fluorooxirane can be replaced with another miscible solvent.

The perfluoropolyether lubricant includes one or more perfluoropolyether compounds containing the repeating unit (CₐF₂ₐO); in which a is an integer from 1 to about 8 or from 1 to about 4. These repeating units can be linear or branched. Many of the perfluoropolyether lubricants useful in the invention have been described previously such as in U.S. Pat. No. 4,671,999 (Burguette et al.), U.S. Pat. No. 4,268,556 (Pedrotty), U.S. Pat. No. 4,803,125 (Takeuchi et al.), U.S. Pat. No. 4,721,795 (Caporiccio et al.), U.S. Pat. No. 4,746,575 (Scaretti et al.), U.S. Pat. No. 4,094,911 (Mitsch et al.), and U.S. Pat. No. 5,663,127 (Flynn et al.). These patents are hereby incorporated by reference.

Typically, the perfluoropolyether lubricant is a liquid at room temperature. Such a lubricating liquid, otherwise known as a fluid, can have a wide range of viscosities. In some embodiments, the lubricant is a viscous oil. The molecular weight is usually high enough to prevent volatilization or removal of the lubricant from the substrate during use. When the substrate is a magnetic disk, the molecular weight of the lubricant is usually high enough to prevent the removal of the lubricant by centrifugal forces created when the disk is rotated relative to either the read or record head.

Typically, the perfluoropolyether lubricant can be represented by the formula:

A-(C_{y}F_{2y})O(C₄F₈O)ₖ(C₃F₆O)ₘ(C₂F₄O)ₙ(C_{F2}O)ₚ(C_{z}F_{2z})-A′ II

where y and z are independent integers from 0 to about 20; the variables k, m, n, and p are independent integers from 0 to about 200; and the sum of k, m, n, and p is from 2 to about 200. The repeating units can be randomly distributed in the backbone of the lubricant molecule. Each of the groups C_{y}F_{2y}, C_{z}F_{2z}, C₄F₈O, C₃F₆O, and C₂F₄O in Formula II can be linear or branched. The A and A′ end groups are independently selected monovalent organic moieties that have from 1 to 20 carbon atoms. The end groups can be either hydrogen-containing or nonhydrogen-containing and can include heteroatoms such as oxygen, nitrogen, sulfur, or a halogen other than fluorine.

In some embodiments, a major amount of the lubricant includes perfluoropolyether compounds containing at least one hydrogen-containing end group. In this embodiment, minor amounts of the lubricant can include compounds having only nonhydrogen-containing end groups. In another embodiment, a major amount of the lubricant includes perfluoropolyether compounds containing two hydrogen-containing end groups. In this embodiment, minor amounts of the lubricant can include compounds having only one hydrogen-containing end group or two nonhydrogen-containing end groups.

Nonhydrogen-containing A and A′ groups include, for example, —CF₂CF₃, —CF₃, —F, —OCF₂CF₃, —OCF₃, —CF₂C(O)F, and —C(O)F. An example of a perfluoropolyether with nonhydrogen-containing end groups is:

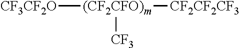

where m is an integer having a value such that the lubricant has a number average molecular weight in the range of 1000 to 5000. This type of lubricant is commercially available as KRYTOX™ 142 from E. I. Dupont deNemours & Company of Wilmington, Del. Other nonhydrogen-containing perfluoropolyether lubricants include, for example, certain types of FOMBLIN™ fluids such as FOMBLIN™ Y and Z (available from Solvay) as well as certain types of DEMNUM™ fluids such as DEMNUM™ SA and SP (available from Dalkin Industries, Ltd. of Tokyo, Japan).

Examples of hydrogen-containing A and A′ groups are alkyl, aryl, and alkaryl groups, which can be partially substituted with fluorine atoms and can contain heteroatoms, such as oxygen, sulfur, and nitrogen, for example. Particularly useful examples of such hydrogen-containing end groups include:

(a) —B-D groups wherein:

### (i) B is: —CH₂O—, —CH₂—O—CH₂—, —CF₂—, and —CF₂O—; and

### (ii) D is:

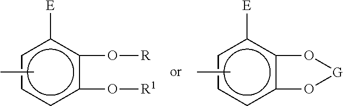

wherein R and R¹ are independently alkyl groups having 1 to 3 carbon atoms; G is a divalent alkyl group having 1 to 5 carbon atoms; and E is —H, —OH, —OCH₃, —OC₂H₅, or —OC₃H₇ (each R, R′, and G group can be substituted with one or more halogen atoms);
(b) —(CₜH₂ₜ)SH, —(CₜH₂ₜ)SR², —(CₜH₂ₜ)NR²₂, —CO₂R², —(CₜH₂ₜ)CO₂H, —(CₜH₂ₜ)SiR²_{z}Q_{3z}, —(CₜH₂ₜ)CN, —(CₜH₂ₜ)NCO, —(CₜH₂ₜ)CH═CH₂,

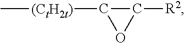

—(CₜH₂ₜ—)CO₂R², —(CₜH₂ₜ)OSO₂CF₃, —(CₜH₂ₜ)OC(O)Cl, —(CₜH₂ₜ)OCN, —(O)COC(O)—R², —(CₜH₂ₜ)X, CHO, —(CₜH₂ₜ)CHO, CH(OCH₃)₂, —(CₜH₂ₜ)CH(OCH₃)₂, —(CₜH₂ₜ)SO₂Cl, C(OCH₃)═NH, C(NH₂)═NH, —(CₜH₂ₜ)OC(O)CH═CH₂, —(CₜH₂ₜ)OC(O)C(CH₃)═CH₂,

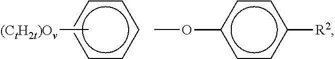

### —(CₜH₂ₜ)OR²,

### —(CₜH₂ₜ)OC(O)R²,

### —(CₜH₂ₜ)(CₜH₂ₜO)ₓH,

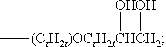

wherein Q is —OH, —OR³, —H, —Cl, —F, —Br, or —I; R² is hydrogen, an aryl group containing 6 to 10 carbons, or an alkyl group containing 1 to 4 carbons; R³ is an alkyl group containing 1 to 4 carbons; X is Cl, Br, F, or I; z is an integer ranging from 0 to 2; x is an integer ranging from 1 to 10; v is an integer ranging from 0 to 1; and t is an integer ranging from 1 to 4;
(c) —OCR⁴R⁵R⁶, where in R⁴ is hydrogen, an alkyl or fluoroalkyl group containing 1 to 4 carbons; R⁵ is hydrogen or an alkyl group containing 1 to 4 carbons; and R⁶ is fluoroalkyl group containing 1 to 4 carbon atoms; and

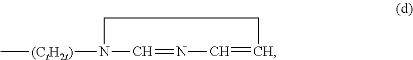

where t is defined as above.

Specific examples of particularly preferred perfluoropolyethers having functional end groups according to formula I include:

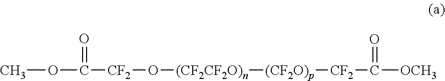

wherein n and p are integers, each having an independent value such that the lubricant has a number average molecular weight in the range of 1000 to 5000 (an example of such a compound is commercially available as FOMBLIN™ Z-DEAL from Solvay);

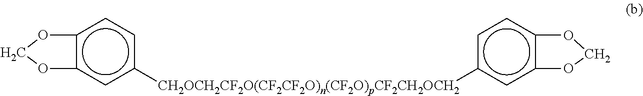

wherein n and p are integers, each having an independent value such that the lubricant has a number average molecular weight in the range of 1000 to 5000 (examples of such compounds are commercially available as FOMBLIN™ AM 2001 and AM 3001 from Solvay);

HOCH₂—CF₂—O—(CF₂CF₂O)ₙ—(CF₂O)ₚ—CF₂—CH₂OH (c)

wherein n and p are integers, each having an independent value such that the lubricant has a number average molecular weight in the range of 1000 to 5000 (an example of such a compound is commercially available as FOMBLIN™ Z-DOL from Solvay);

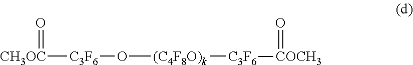

wherein k is an integer having a value such that the lubricant has a number average molecular weight in the range of 1000 to 5000;

HOCH₂—C₃F₆—O—(C₄F₈O)ₖ—C₃F₆—CH₂OH (e)

wherein k is an integer having a value such that the lubricant has a number average molecular weight in the range of 1000 to 5000;

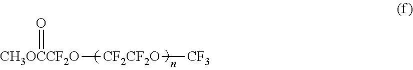

wherein n is an integer having a value such that the lubricant has a number average molecular weight in the range of 1000 to 5000;

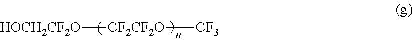

wherein n is an integer having a value such that the lubricant has a number average molecular weight in the range of 1000 to 5000;

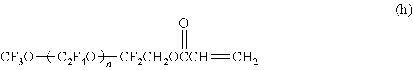

wherein n is an integer having a value such that the lubricant has a number average molecular weight in the range of 1000 to 5000;

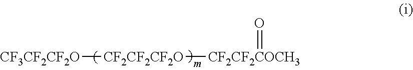

wherein m is an integer having a value such that the lubricant has a number average molecular weight in the range of 1000 to 5000 (an example of such a compound is commercially available as DEMNUM™ ester from Daikin Industries, Ltd.);

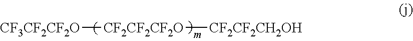

wherein m is an integer having a value such that the lubricant has a number average molecular weight in the range of 1000 to 5000 (an example of such a compound is commercially available as DEMNUM™ alcohol from Daikin Industries, Ltd.);

OCNCH₂—CF₂—O—(CF₂CF₂O)ₙ—(CF₂O)ₚ—CF₂—CH₂NCO (k)

wherein n and p are integers, each having an independent value such that the lubricant has a number average molecular weight in the range of 1000 to 5000 (an example of such a compound is commercially available as FOMBLIN™ Z-DISOC from Solvay);

H(OH₄C₂)_{1.5}OCH₂—CF₂—O—(CF₂CF₂O)ₙ—(CF₂O)ₚ—CF₂—CH₂O(C₂H₄O)_{1.5}H (l)

wherein n and p are integers, each having an independent value such that the lubricant has a number average molecular weight in the range of 1000 to 5000 (an example of such a compound is commercially available as FOMBLIN™ Z-DOL-TX from Solvay);

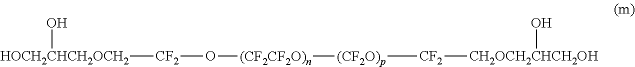

wherein n and p are integers, each having an independent value such that the lubricant has a number average molecular weight in the range of 1000 to 5000 (an example of such a compound is commercially available as FOMBLIN™ Z-TETRAOL from Solvay): and

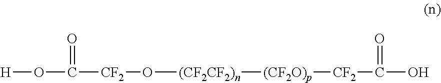

wherein n and p are integers, each having an independent value such that the lubricant has a number average molecular weight in the range of 1000 to 5000 (an example of such a compound is commercially available as FOMBLIN™ Z-DIAC from Solvay).

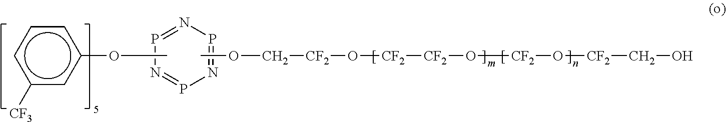

Wherein m and n are integers, each having an independent value such that the lubricant has a number average molecular weight in the range of 1000 to 5000 (an example of such a compound is commercially available Phosfarol A20H-2000 from Moresco).

Methods of making compounds according to the formulae listed as examples (d) to (h) are described in U.S. Pat. No. 5,039,432 (Ritter et al.).

In some embodiments, the lubricant compositions further comprises various additives. Suitable additives include, for example, cyclic phosphazene compounds such as Dow X-1P and X-100 (available from Dow Chemical of Midland, Mich.). The additives can enhance the performance of the lubricant, for example, by reducing the rate of lubricant breakdown and wear. The additives are usually added at levels from about 0.1 ppm to about 1000 ppm based on the weight of the lubricant composition. In other embodiments, the additives are present in concentrations from about 1 ppm to about 300 ppm or from about 10 ppm to about 250 ppm.

Another aspect of the invention provides a method of lubricating a substrate. The method comprises applying a coating of a lubricant composition to a substrate followed by removing the solvent from the coating to form a neat lubricant film. The lubricant composition comprises 0.01 to 10 wt. % perfluoropolyether lubricant and about 90.0 to about 99.99 weight percent fluorooxirane based on the weight of the lubricant composition. The fluorooxirane solvent is removed during the drying step. Typically, the substrate is magnetic media including, for example, thin films and hard disks. The magnetic media typically consists of a base layer such as glass, aluminum or a polymeric material and a magnetic layer containing iron, cobalt, nickel, or the like. The magnetic media can contain optional layers of carbon or other materials to enhance, for example, durability and performance of the media. The lubricant is usually applied as the outermost layer.

To meet the demands for increased data storage densities, the magnetic recording industry has had to develop magnetic media with significantly higher signal output levels. The higher signal output levels have been achieved, at least in part, by providing smoother, lower defect magnetic media containing thinner lubricant coatings. The decreased thickness of the lubricant coating allows the magnetic head to be in closer proximity to the magnetic material in the media. However, if the thickness of lubricant coating is too thin, the durability of the magnetic media can be compromised. The thickness of the lubricant layer is typically less than about 2 nm in state-of-the-art magnetic media.

Although the lubricant composition can be applied to the substrate by any known process, two methods are widely used for application of lubricants to hard disks. The first method involves placing a hard disk in a coating chamber. The lubricant composition is pumped into the coating chamber to completely cover the disk. The lubricating composition is then drained from the chamber at a controlled rate leaving a uniform coating on surface of the disk. The second application method involves dipping a hard disk into a vessel containing the lubricant composition and then slowly pulling the disk back out.

With either the draining or dipping application method, the thickness of the lubricant coating can be controlled by varying the concentration of the lubricant in the lubricant composition and the speed of either draining the lubricant composition or pulling the disk out of the lubricant composition. Lowering the concentration of the perfluoropolyether in the lubricant composition can decrease the thickness of the lubricant coating. Similarly, either decreasing the rate of removal of the hard disk from the lubricant composition using the draining technique or decreasing the rate of removal of the hard disk from the lubricant composition using the dipping technique can decrease the thickness of the lubricant coating.

The fluorooxirane solvent can be removed, for example, by drying or evaporating at ambient or higher temperatures. Temperatures up to about 150° C. can be used for solvent removal. The rate of removal can be increased through the use of a non-reactive gas such as, for example, nitrogen or argon to assist evaporation of the solvent. As the solvent is removed, the lubricant forms a uniform film over the substrate.

In addition to coating applications, the fluorooxirane compounds can be used in other applications. For example, the compounds can be used as solvents for precision or metal cleaning of electronic articles such as disks or circuit boards; as carrier fluids or solvents for document or specimen preservation materials and for lubricants; as displacement drying agents for removing water, such as from jewelry or metal parts; and as strippers for photoresists when used with, for example, a chlorohydrocarbon such as 1,1,1-trichloroethane or trichloroethylene.

The fluorooxirane compounds are useful as solvents for cleaning and drying applications such as, for example, those described in U.S. Pat. No. 5,125,089 (Flynn et al.), U.S. Pat. No. 3,903,012 (Brandreth), U.S. Pat. No. 4,169,807 (Zuber), and U.S. Pat. No. 5,925,611 (Flynn et al.) the descriptions of which are incorporated herein. Both organic and inorganic substrates can be cleaned by contacting them with a composition comprising at least one fluorooxirane. Most contaminants can be removed, including hydrocarbon contaminants, fluorocarbon contaminants, particulates, and water.

In using the compounds for the drying of or displacing water from the surface of articles (such as circuit boards), the process of drying or water displacement described in, for example, U.S. Pat. No. 5,125,978 (Flynn et al.) can be used. Broadly, such process comprises contacting the surface of an article with a liquid composition comprising at least one fluorooxirane, preferably in admixture with a non-ionic fluoroaliphatic surface active agent. The wet article is immersed in the liquid composition and agitated therein, the displaced water is separated from the liquid composition, and the resulting water-free article is removed from the liquid composition. Further description of the process and the articles that can be treated can be found in said U.S. Pat. No. 5,125,978 (Flynn et al.), which description is incorporated herein.

In cleaning applications, the fluorooxirane compounds can be used alone or in admixture with each other or with other commonly-used solvents (for example, ethers, alkanes, alkenes, perfluorocarbons, perfluorinated tertiary amines, perfluoroethers, cycloalkanes, esters, ketones, aromatics, siloxanes, hydrochlorocarbons, hydrochlorofluorocarbons, hydrofluorocarbons, and the like, and mixtures thereof). Such co-solvents are preferably at least partially fluorinated, can be chosen to modify or enhance the properties of a composition for a particular use, and can be utilized in ratios (of co-solvent(s) to fluorooxirane (s)) such that the resulting composition preferably has no flash point. If desired, the fluorooxirane compounds can be used in combination with other compounds that are very similar in properties relative to a particular use (for example, other fluorochemical compounds.

For each application, minor amounts of optional components can be added to the compounds to impart particular desired properties for particular uses. Useful compositions can comprise conventional additives such as, for example, surfactants, coloring agents, stabilizers, anti-oxidants, flame retardants, and the like, and mixtures thereof.

Objects and advantages of this invention are further illustrated by the following examples, but the particular materials and amounts thereof recited in these examples, as well as other conditions and details, should not be construed to unduly limit this invention.

### EXAMPLES

TABLE 1
Materials

| Chemical | Description | Source |
|---|---|---|
| 2,3-difluoro-2-(1,2,2,2- | C6 Oxirane | Preparation 1 |
| tetrafluoro-1-trifluoromethyl- | | |
| ethyl)-3-trifluoromethyl-oxirane | | |
| 1,2,2,3,3,4,4,5,5,6-decafluoro-7- | cC6 Oxirane | Preparation 2 |
| oxa-bicyclo[4.1.0]heptane | | |
| HFP Trimer-oxirane | C9 Oxirane | Preparation 3 |
| 1,1,1,2,3,4,5,5,5-nonafluoro-4- trifluoromethyl-pent-2-ene (Perfluoro-4-methyl-2-Pentene) | 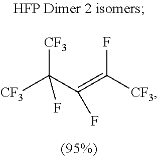 [SMILES: F/C(=C(/F)C(F)(C(F)(F)F)C(F)(F)F)C(F)(F)F] 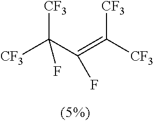 [SMILES: FC(=C(C(F)(F)F)C(F)(F)F)C(F)(C(F)(F)F)C(F)(F)F] | 3M Foam Additive FA-188, 3M St. Paul MN, |
| 1,2,3,3,4,4,5,5,6,6 decafluoro- cyclohexene (Perfluorocyclohexene) | 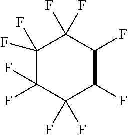 | Available from Sigma-Aldrich, St. Louis, MO. |
| Sodium Hydroxide | NaOH | GFS Chemicals, |
| | | Inc., |
| | | Powell, OH |
| Sodium Hypochlorite | Na⁺[ClO]⁻ | Alfa Aesar, |
| | | Ward Hill, MA |
| Potassium Hydroxide | KOH | Sigma Aldrich, |
| | | Milwaukee, WI |
| Hydrogen Peroxide | H₂O₂ | GFS Chemicals, |
| | | Inc., |
| | | Powell, OH |
| Acetonitrile | CH₃CN | Honeywell |
| | | Burdick & |
| | | Jackson, |
| | | Morristown, NJ |
| HFP Trimer | 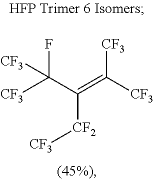 [SMILES: FC(F)(F)C(=C(C(F)(F)C(F)(F)F)C(F)(C(F)(F)F)C(F)(F)F)C(F)(F)F] 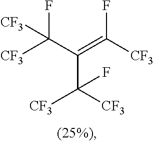 [SMILES: FC(=C(C(F)(C(F)(F)F)C(F)(F)F)C(F)(C(F)(F)F)C(F)(F)F)C(F)(F)F] 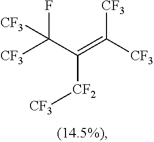 [SMILES: FC(F)(F)C(=C(C(F)(F)C(F)(F)F)C(F)(C(F)(F)F)C(F)(F)F)C(F)(F)F] 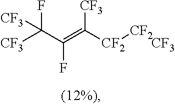 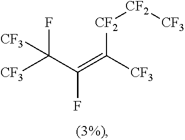 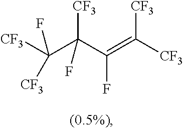 [SMILES: FC(=C(C(F)(F)F)C(F)(F)F)C(F)(C(F)(F)F)C(F)(C(F)(F)F)C(F)(F)F] | U.S. Pat. No. 5,254,774 |
| HOCH₂CF₂O(CF₂CF₂O)ₙ(CF₂O)ₚ | FOMBLIN Z-DOL 2500 | Solvay SA, |
| CF₂CH₂OH | | Brussels, |
| | | Belgium |
| 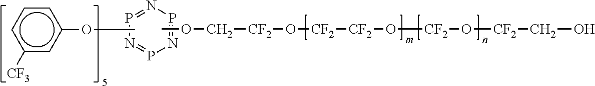 | Phosfarol A20H-2000 | Moresco, Kobe-city, Hyogo, Japan |
| 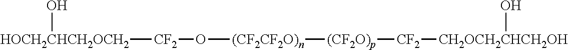 | FOMBLIN Z-Tetrazol S Grade | Solvay SA, Brussels, Belgium |
| | NFD-ZT-33-00 (ZT3300) | Separex; |
| | | Champignuelles, |
| | | France |
| | NFD-ZT-40-00 (ZT4000) | Separex; |
| | | Champignuelles, |
| | | France |
| | NFD-ZT-56-00 (ZT5600) | Separex; |
| | | Champignuelles, |
| | | France |
| 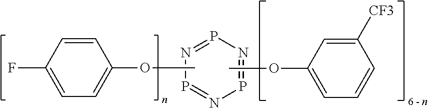 | X-1P Lubricant Additive | Dow Chemical Co, Midland, MI |
| | PF-5060DL | 3M Company, |
| Dioctylphthlate | | St Paul, MN |
| | DOP | Milsolv |
| | | Corporation, |
| | | St Paul, MN |
| Methoxy-nonafluorobutane | NOVEC 7100 | 3M Company, |
| | | St Paul, MN |
| 2,3-Dihydrodecafluoropentane | VERTREL XF | Dupont, |
| | | Wilmington, DE |

### Solubility Testing

A disposable glass vial was placed on a four-place balance and the mass (M_{V}) recorded. The balance with the glass vial was tared and deposition solvent was added (varying from 1 g to 5 g) and the mass (M_{S}) was recorded. The balance with the deposition solvent in the glass vial was tared again. The lubricant was added in a dropwise fashion using a disposable plastic pipet and the mass (M_{L}) recorded. The glass vial was then mixed by hand for 10 seconds to 30 seconds and the solution clarity was visually observed and recorded. If the solution was hazy, the lubricant was considered to have exceeded the solubility limit of the deposition solvent. If the solution was clear, additional drops of lubricant were added to the glass vial, the mass (M_{L}) was recorded, the glass vial was shaken, and the solution clarity was observed. This process was continued until a hazy solution was observed or more than 10% w/w (weight of lubricant to combined weight of lubricant and deposition solvent) was reached. After a hazy solution or more than 10% w/w was reached, the glass vial with the solution was removed from the balance. The balance was tared and the final mass (M_{F}) of the glass vial with deposition solvent and lubricant was measured and recorded. To account for the evaporative losses of the deposition solvent during the experiment, the mass of the vial and the mass of the lubricant added were subtracted from the total mass of the vial with the deposition solvent and lubricant to determine the final mass of deposition solvent (M_{S}*) in the vial (i.e., M_{S}*=M_{F}−M_{V}−M_{L}). Solubility of the lubricant in deposition solvents was calculated as M_{L}/(M_{L}+M_{S}*) and reported in % w/w (weight/weight).

The lubricants described above were mixed with deposition solvents and the solubility results are shown in Table 2. If the endpoint was not clearly observed, the solubility experiment was repeated. Where a range is reported for solubility, the lower number is the highest soluble value and the higher number is the lowest insoluble value.

### Preparation 1—Synthesis of 2,3-difluoro-2-(1,2,2,2-tetrafluoro-1-trifluoromethyl-ethyl)-3-trifluoromethyl-oxirane

In a 1.5 liter glass reactor fitted with a mixer and a cooling jacket, 400 grams of acetonitrile, 200 grams of 1,1,1,2,3,4,5,5,5-nonafluoro-4-trifluoromethyl-pent-2-ene and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature at 0° C. After all the hydrogen peroxide was added within about 2 hours, the mixer was turned off to allow the product crude to phase split from solvent and aqueous phases. 155 grams of the product crude was collected from the bottom product phase. The product crude was then washed with 200 grams of water to remove solvent acetonitrile and then purified in a 40-tray Oldershaw fractionation column with condenser being cooled to 15° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 52° C. and 53° C.

The 90 grams of the final product collected from the method above was analyzed by 376.3 MHz ¹⁹F-NMR spectra and identified as a mixture of 2,3-difluoro-2-(1,2,2,2-tetrafluoro-1-trifluoro-methyl-ethyl)-3-trifluoromethyl-oxirane, 95.8% and 2.2% of 2-fluoro-2-pentafluoroethyl-3,3-bis-trifluoromethyl-oxirane.

### Preparation 2—Oxirane Synthesis and Purification of 1,2,2,3,3,4,4,5,5,6-decafluoro-7-oxa-bicyclo[4.1.0]heptane

In a 1.5 liter glass reactor fitted with a mixer and a cooling jacket, 400 grams of acetonitrile, 200 grams of 1,2,3,3,4,4,5,5,6,6-decafluoro-cyclohexene (89.3% purity) and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature at 0° C. After all the hydrogen peroxide was added within about 2 hours, the mixer was turned off to allow the product crude to phase split from solvent and aqueous phases. 100 grams of the product crude was collected from the bottom product phase. The product crude was then washed with 100 grams of water to remove solvent acetonitrile and then purified in a 40-tray Oldershaw fractionation column with condenser being cooled to 15° C. The fractionation column was operated in such a way that the reflux ratio (the distillate flow rate going back to the fractionation column to the distillate flow rate going to the product collection cylinder) was at 10:1. The final product was collected as the condensate when the head temperature in the fractionation column was between 47° C. and 55° C.

The 70 grams of the final product collected from the method above was analyzed by 376.3 MHz ¹⁹F-NMR spectra and identified as 1,2,2,3,3,4,4,5,5,6-decafluoro-7-oxa-bicyclo[4.1.0]heptane with a purity of 94.1% with an additional 2.6% isomers.

### Preparation 3—C₉ Oxirane Synthesis and purification of HFP Trimer-oxirane (C₉F₁₈O)

In a 1.5 liter glass reactor fitted with a mixer and a cooling jacket, 400 grams of acetonitrile, 200 grams of HFP Trimer (C₉F₁₈), and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature between 0° C. and 20° C. After all the hydrogen peroxide was added within about 2 hours, the mixer was turned off to allow the product crude to phase split from solvent and aqueous phases. 180 grams of the product crude was collected from the bottom product phase. The product crude was then washed with 200 grams of water to remove solvent acetonitrile and then purified in a 40-tray Oldershaw fractionation column with condenser being cooled to 15° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 120° C. and 122° C.

The 150 grams of the final product collected from the method above was analyzed by 376.3 MHz ¹⁹F-NMR spectra and identified as oxiranes of HFP trimer (C₉F₁₈O) with 5 isomeric forms. The sum of all 5 isomers had a purity of 99.4%.

### Preparation 4—Synthesis of 2-nonafluorobutyloxirane [C₄F₉CH(O)CH₂]

The oxirane was prepared according to a modification of the procedure of WO2009/096265 (Daikin Industries Ltd.). A 500 mL, magnetically stirred, three-necked round bottom flask was equipped with a water condensor, thermocouple and an addition funnel. The flask was cooled in a water bath. Into the flask were placed C₄F₉CH═CH₂ [50 g, 0.2 mol, Alfa Aesar], N-bromosuccinimide [40 g, 0.22 mol, Aldrich Chemical Company] and dichloromethane as the solvent [250 mL]. Chlorosulfonic acid [50 g, 0.43 mol, Alfa Aesar] was placed in the addition funnel and added slowly to the stirred reaction mixture while keeping the reaction temperature below 30° C. After the addition was completed the reaction mixture was held at ambient temperature for 16 hours. The entire reaction mixture was then poured carefully onto ice, the lower dichloromethane phase separated and washed once more with an equal volume of water and the solvent removed by rotary evaporation yielding 82 g of the chlorosulfite C₄F₉CHBrCH₂OSO₂Cl in about 65% purity by glc and which contained some C₄F₉CHBrCH₂Br. The chlorosulfite mixture was used without further purification in the next step.

The chlorosulfite, benzyltrimethylammonium chloride [0.6 g, 0.003 mol, Alfa Aesar] and water [350 mL] were placed in a 1 L, magnetically stirred, three-necked round bottom flask which was equipped with a water condensor, thermocouple and an addition funnel. A solution of potassium iodide [66.3 g, 0.4 mol, EMD Chemicals Inc.] dissolved in water [66 mL] was placed in the reparatory funnel and added to the chlorosulfite solution dropwise over about 1.5 hours and the mixture stirred for 16 hours at ambient temperature. Dichloromethane [300 mL] was then added, the mixture filtered and the filter cake washed with an additional 100 mL of dichloromethane. The dichloromethane layer was separated and the remaining aqueous layer extracted with an additional 200 mL of dichloromethane. The dichloromethane solvent was then removed by rotary evaporation. The residue, combined with material from another preparation, was distilled bp=66-70° C./20 torr and the distillate once again dissolved in dichloromethane and washed one time with 5% aqueous sodium bisulfite to remove iodine and the solvent removed by rotary evaporation. At this stage the desired product bromohydrin (82 g) C₄F₉CHBrCH₂OH had a purity of 87% and contained about 5% C₄F₉CHBrCH₂Br and 8% C₄F₉CHClCH₂Br.

The bromohydrin (82 g), diethyl ether solvent (200 mL) and tetrabutylammonium bromide [3.0 g, 0.009 mol, Aldrich] were placed in a 500 mL, magnetically stirred, round bottom flask equipped with a condensor and thermocouple. To this mixture was added all at once a solution of sodium hydroxide [24 g, 0.6 mol] in water [33 g]. The mixture was stirred vigorously for four hours. The ether solution was then washed once with saturated sodium chloride solution and once with 5% HCl solution and subsequently dried over magnesium sulfate and the residue fractionally distilled through a concentric tube column with the fraction boiling at 101° C. collected to give a product (40.9 g) which was 88.5% the desired oxirane C₄F₉CH(O)CH₂ and 7.3% bromoolefin C₄F₉CBr═CH₂. Final purification of the epoxide by removal of most of the bromoolefin was carried out by reaction of the oxirane/bromoolefin mixture, which was degassed three times under nitrogen using a Firestone valve connected to a source of dry nitrogen and mineral oil bubbler, with 2,2′-azobis(2-methylpropionitrile) [0.5 g, 0.003 mol, Aldrich] and bromine [4.0 g, 0.025 mol, Aldrich] at 65° C. for eight hours. The reaction mixture was treated with an aqueous solution of 5% by weight sodium bisulfate to remove the excess bromine, the phases were separated and the lower phase fractionally distilled through a concentric tube column to afford the final oxirane (25 g) in 97.9% purity (b.p.=102° C.). The product identity was confirmed by GCMS, H-1 and F-19 NMR spectroscopy.

### Preparation 5—Synthesis of 2-tridecafluorohexyloxirane [C₆F₁₃CH(O)CH₂]

A 1 L, magnetically stirred, three-necked round bottom flask was equipped with a water condensor, thermocouple and an addition funnel. The flask was cooled in a water bath. Into the flask were placed fuming sulfuric acid (20% SO₃ content) [345 g, 0.86 mol SO₃, Aldrich] and bromine [34.6 g, 0.216 mol, Aldrich]. Into the addition funnel was placed C₆F₁₃CH═CH₂ [150 g, 0.433 mol, Alfa Aesar] which was added to the acid solution over a two hour period. There was no noticeable exotherm. The reaction mixture was stirred at ambient temperature for 16 hours. Water [125 g] was placed in the separatory funnel and added very cautiously over about a two hour period. The initial 5-10 g addition was extremely exothermic. Once the addition was complete, more water [50 g] was added all at once and the reaction mixture heated to 90° C. for 16 hours. Diethyl ether [300 mL] was added to the reaction mixture and the two phases separated with the lower phase containing the product. The remaining aqueous phase was extracted once more with ether [150 mL], the upper ether phase separated and combined with the previous lower phase. The ether layer was washed with 5% by weight aqueous potassium hydroxide solution and the solvent removed by rotary evaporation to give 112 g of a white crystalline solid which was about 72% C₆F₁₃CHBrCH₂OH, 8% C₆F₁₃CHBrCH₂Br and 19% [C₆F₁₃CHBrCH₂O]SO₂. This solid was distilled and the fraction collected (36 g) of boiling range=68-74° C./6 torr which was found to be 90.7% the desired bromohydrin and 9.3% the dibromide.

The bromohydrin mixture was then placed in a 250 mL, magnetically stirred, round bottom flask equipped with a water condensor and thermocouple along with tetrabutylammonium bromide [1.5 g, 0.005 mol, Aldrich] dissolved in 5 g water and a solution of 8.2 g of sodium hydroxide [0.2 mol] dissolved in 15 g water. After one hour of vigorous stirring the reaction mixture was analyzed by glc which showed about a 40% conversion of the bromohydrin to the oxirane. The reaction was stirred for an additional 5 hours. The lower aqueous phase was separated and the remaining ether phase washed once with dilute aqueous hydrochloric acid, prepared by adding a few drops of 2N aqueous HCl to 50 mL water, dried over magnesium sulfate and distilled to afford the product oxirane (12 g) C₆F₁₃CH(O)CH₂ in 98.3% purity [b.p.=144° C.] and 1.5% bromoolefin C₆F₁₃CBr═CH₂. The product structure was confirmed by GCMS, H-1 and F-19 NMR.

TABLE 2
Solubility Properties of Perfluorooxiranes

| | c-C6 | C6 | C9 | | NOVEC | VERTREL |
|---|---|---|---|---|---|---|
| Material | Oxirane | Oxirane | Oxirane | PF-5060DL | 7100 | XF |
| Lubricants | | | | | | |
| Z-DOL | >10% | >10% | >10% | >10% | >10% | >10% |
| A20H | >10% | >10% | >10% | >10% | >10% | |
| Z-Tetraol | 1.5% | <0.4% | 0.1-0.4% | <0.1% | <0.1% | >10% |
| ZT3300 | >10% | 1-2% | 1-2% | 0.55% | >10% | |
| ZT4000 | >10% | <1% | <1% | 0.25% | 3.2-3.4% | |
| ZT5600 | >10% | <1% | 1.0-2.5% | 0.65% | <10% | |
| Additives | | | | | | |
| X-1P | <0.7% | <0.5% | <0.5 | 0.04% | >10% | >10% |
| Impurities | | | | | | |
| DOP | <0.6% | <0.9% | <1.1% | <0.005% | 5.1% | >30% |

TABLE 3
Solubility Properties of Fluorooxiranes

Material

| Lubricants | C₄F₉CH(O)CH₂ | C₆F₁₃CH(O)CH₂ |
|---|---|---|
| Z-DOL | >10% | >10% |
| A20H | >10% | >10% |
| Z-Tetraol | >10% | 0.7-1.0% |

The invention is illustrated with the following embodiments.
1. A lubricant composition comprising a C₄ to C₁₅ fluorooxirane fluid having a boiling point ≧20° C., and a lubricant soluble or dispersible therein.
2. The lubricant composition of embodiment 1 wherein the fluorooxirane is a perfluorooxirane.
3. The lubricant composition of embodiment 1 comprising a fluorooxirane of the formula:

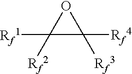

wherein each of R_{f}¹, R_{f}², R_{f}³ and R_{f}⁴ are selected from a hydrogen atom, a fluorine atom or a fluoroalkyl group, and the sum of the carbon atoms of said fluorooxirane is 4 to 15, and any two of said R_{f} groups may be joined together to form a perfluorocycloalkyl ring.
4. The lubricant composition of embodiment 2 wherein the perfluorooxirane is a C₅ to C₉ perfluorooxirane.
5. The lubricant composition of embodiment 2 comprising a perfluorooxirane of the formula

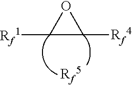

wherein each of R_{f}¹, and R_{f}⁴ are selected from a hydrogen atom, a fluorine atom or a fluoroalkyl group, and R_{f}⁵ is a fluoroalkylene group of 2 to 5 carbon atoms, and the sum of the carbon atoms is 4 to 15.
6. The lubricant composition of any of embodiments 1-5 wherein the fluorooxirane has a global warming potential of less than 10,000.
7. The lubricant composition of embodiment 1 wherein the fluorooxirane is selected from 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, and oxiranes of HFP trimers, including 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane, 2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane.
8. The lubricant composition of any of embodiments 1 to 7 comprising:
(a) 0.01 to 10 wt. % perfluoropolyether lubricant; and
(b) 90 to about 99.99 fluorooxirane solvent based on the weight of the lubricant composition.
9. The lubricant composition of any of embodiments 1 to 7, wherein the fluorooxirane has a boiling point of less than about 150° C.
10. The lubricant composition of any of embodiments 1 to 9, wherein up to 50 weight percent of the fluorooxirane solvent is replaced with a co-solvent selected from the group consisting of a hydrofluorocarbon, hydrochlorofluorocarbon, perfluorocarbon, perfluoropolyether, hydrofluoroether, hydrochlorofluoroether, hydrofluoropolyether, fluorinated aromatic compound, chlorofluorocarbon, bromofluorocarbon, bromochloroflurocarbon, hydrobromocarbon, iodofluorocarbon, hydrobromofluorocarbon, fluorinated ketones and mixtures thereof
11. The lubricant composition of embodiment 10, wherein the co-solvent has 5 to 10 carbon atoms.
12. The lubricant composition of any of embodiments 1 to 11, further comprising 0.1 to 1,000 ppm of an additive.
13. The lubricant composition of embodiment 12, wherein the additive is a cyclic phosphazene compound.
14. The lubricant composition of any of embodiments 1 to 13, wherein the perfluoropolyether lubricant comprises a perfluoropolyether compound represented by the formula:

A(C_{y}F_{2y})O(C₄F₈O)ₖ(C₃F₆O)ₘ(C₂F₄O)ₙ(CF₂O)ₚ(C_{z}F_{2z})A′
wherein:
(a) y is an integer from 0 to about 20;
(b) z is an integer from 0 to about 20;
(c) k, m, n, and p are independent integers from 0 to about 200, wherein the sum of k, m, n, and p ranges from 2 to about 200; and
(d) the A and A′ end groups are independently selected monovalent organic moieties.
15. The lubricant composition of embodiment 14, wherein at least one of the A and A′ end groups is a hydrogen-containing monovalent organic moiety.
16. A lubricant composition comprising:
   (a) about 0.01 to 10 wt. % of a perfluoropolyether lubricant of formula:

A(C_{y}F_{2y})O(C₄F₈O)ₖ(C₃F₆O)ₘ(C₂F₄O)ₙ(CF₂O)ₚ(C_{z}F_{2z})A′
wherein:
   (i) y is an integer from 0 to about 20;
   (ii) z is an integer from 0 to about 20;
   (iii) k, m, n, and p are independent integers from 0 to about 200, wherein the sum of k, m, n, and p ranges from 2 to about 200; and
   (iv) the A and A′ end groups are independently selected monovalent organic moieties; and
(b) about 90 to about 99.99 weight percent a fluorooxirane solvent based on the weight of the lubricant composition, wherein the fluorooxirane solvent has 4 to 10 carbon atoms, and a boiling point of ≧20° C.
17. A method of lubricating a substrate comprising:
   (a) applying to a substrate a coating of a lubricant composition according to any of embodiments 1 to 16; and
   (b) removing the fluorooxirane from the coating.
18. The method of embodiment 17, wherein the substrate is magnetic media.

1. A lubricant composition comprising 90 to about 99.99 wt. % of a C₄ to C₁₅ fluorooxirane fluid having a boiling point 20° C., and 0.01 to 10 wt. % of a perfluoropolyether lubricant soluble or dispersible therein.

2. The lubricant composition of claim 1 wherein the fluorooxirane is a perfluorooxirane.

3. The lubricant composition of claim 1 comprising a fluorooxirane of the formula: 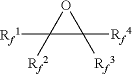
wherein each of R_{f}¹, R_{f}², R_{f}³ and R_{f}⁴ are selected from a hydrogen atom, a fluorine atom or a fluoroalkyl group, and the sum of the carbon atoms of said fluorooxirane is 4 to 15, and any two of said R_{f} groups may be joined together to form a perfluorocycloalkyl ring, wherein the fluorooxirane has 3 or fewer hydrogen atoms.

4. The lubricant composition of claim 2 wherein the perfluorooxirane is a C₅ to C₉ perfluorooxirane.

5. The lubricant composition of claim 2 comprising a perfluorooxirane of the formula 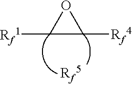
wherein each of R_{f}¹, and R_{f}⁴ are selected from a hydrogen atom, a fluorine atom or a fluoroalkyl group, and R_{f}⁵ is a fluoroalkylene group of 2 to 5 carbon atoms, and the sum of the carbon atoms is 4 to 15.

6. The lubricant composition of claim 1 wherein the fluorooxirane has a global warming potential of less than 10,000.

7. The lubricant composition of claim 1 wherein the fluorooxirane is selected from 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, and oxiranes of HFP trimers, including 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane, 2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane.

8. (canceled)

9. The lubricant composition of claim 1, wherein the fluorooxirane has a boiling point of less than about 150° C.

10. The lubricant composition of claim 1, wherein up to 50 weight percent of the fluorooxirane solvent is replaced with a co-solvent selected from the group consisting of a hydrofluorocarbon, hydrochlorofluorocarbon, perfluorocarbon, perfluoropolyether, hydrofluoroether, hydrochlorofluoroether, hydrofluoropolyether, fluorinated aromatic compound, chlorofluorocarbon, bromofluorocarbon, bromochloroflurocarbon, hydrobromocarbon, iodofluorocarbon, hydrobromofluorocarbon, fluorinated ketones and mixtures thereof.

11. The lubricant composition of claim 10, wherein the co-solvent has 5 to 10 carbon atoms.

12. The lubricant composition of claim 1, further comprising 0.1 to 1,000 ppm of an additive.

13. The lubricant composition of claim 12, wherein the additive is a cyclic phosphazene compound.

14. The lubricant composition of claim 1, wherein the perfluoropolyether lubricant comprises a perfluoropolyether compound represented by the formula:
A(C_{y}F_{2y})O(C₄F₈O)ₖ(C₃F₆O)ₘ(C₂F₄O)ₙ(CF₂O)ₚ(C_{z}F_{2z})A′
wherein:
(a) y is an integer from 0 to about 20;
(b) z is an integer from 0 to about 20;
(c) k, m, n, and p are independent integers from 0 to about 200, wherein the sum of k, m, n, and p ranges from 2 to about 200; and
(d) the A and A′ end groups are independently selected monovalent organic moieties.

15. The lubricant composition of claim 14, wherein at least one of the A and A′ end groups is a hydrogen-containing monovalent organic moiety.

16. A lubricant composition comprising:
(a) about 0.01 to 10 wt. % of a perfluoropolyether lubricant of formula:
A(C_{y}F_{2y})O(C₄F₈O)ₖ(C₃F₆O)ₘ(C₂F₄O)ₙ(CF₂O)ₚ(C_{z}F_{2z})A′
wherein:
(i) y is an integer from 0 to about 20;
(ii) z is an integer from 0 to about 20;
(iii) k, m, n, and p are independent integers from 0 to about 200, wherein the sum of k, m, n, and p ranges from 2 to about 200; and
(iv) the A and A′ end groups are independently selected monovalent organic moieties; and
(b) about 90 to about 99.99 weight percent a fluorooxirane solvent based on the weight of the lubricant composition, wherein the fluorooxirane solvent has 4 to 10 carbon atoms, and a boiling point of ≧20° C.

17. A method of lubricating a substrate comprising:
(a) applying to a substrate a coating of a lubricant composition according to claim 1; and
(b) removing the fluorooxirane from the coating.

18. The method of claim 17, wherein the substrate is magnetic media.
